(19) United States
(12) Patent Application Publication
(10) Pub. No.: US 2008/0277976 A1
(43) Pub. Date: Nov. 13, 2008

(54) Seat back assist

(75) Inventor: Donald M. Austin, Perkinsfield (CA)

Correspondence Address: NIXON & VANDERHYE, PC, 901 NORTH GLEBE ROAD, 11TH FLOOR, ARLINGTON, VA, 22203, US

(73) Assignee: M&C Corporation, Sterling Heights, MI (US)

(21) Appl. No.: 12/149,898

(22) Filed: May 9, 2008

Related U.S. Application Data
(60) Provisional application No. 60/924,360, filed on May 10, 2007.

(51) Int. Cl. B60N 2/30

(52) U.S. Cl. 297/2

(57) ABSTRACT

A seat back assist system is disclosed which provides an assist when opening a vehicle split seat back from an upright position and a lift assist when returning the seat back to the upright position from a load floor (horizontal) position. The assist system allows the seat to pop off a latch when released and to fold down to the load floor position. It also provides a lift assist to the upright position.

### CROSS-REFERENCE TO RELATED APPLICATION

This application claims the benefit of Provisional Application No. 60/924,360, filed May 10, 2007, the entire content of which is hereby incorporated by reference in this application.

The present invention relates to vehicle seats, and more particularly, to a system for assisting the pivoting of vehicle foldable rear seat split backs.

### BACKGROUND OF THE INVENTION

Many vehicles today are made with foldable rear seats so that the vehicles can be used to carry longer or larger loads. Typically, the foldable rear seats have seat backs that are split 60/40 and that fold forward to an almost flat position. Although the inclusion of foldable rear seats can increase the utility of a vehicle, it can, nevertheless, be difficult to operate the foldable rear seats because of the weight of the seat backs and/or the location of the seat backs within a vehicle, making it awkward to reach and operate them.

### BRIEF DESCRIPTION OF THE INVENTION

The present invention is a seat back assist system that uses a torque rod assembly to provide an assist when opening a vehicle split seat back from an upright position and a lift assist when returning the seat back to the upright position from a horizontal, load floor position. The assist system torque rod helps the split seats to pop off a latch when released so they can be folded down to the load floor position. The assist system torque rod also provides a lift assist to move the seat backs to the upright position.

### BRIEF DESCRIPTION OF THE DRAWINGS

FIG. 1 shows 60-40 split seat backs in an upright position with the seat back assist system of the present invention.

FIG. 2 shows the free, upright and load floor positions to which the 60-40 seat backs shown in FIG. 1 can be pivoted.

FIG. 3 shows one embodiment of a torque rod used with the seat back assist system of the present invention, with two bends at one end of the torque rod to anchor the torque rod to a floor mounting bracket.

FIG. 4 shows one embodiment of a pivot shaft with a clearance hole in its center for the toque rod used with the seat back assist system to pass through it.

FIG. 5 shows one embodiment of a torque rod retainer including a bore with an inner profile complementing an outer profile of a torque rod on which the retainer is press-fitted.

FIG. 6 shows a completed torque rod assembly used with the seat back assist system of the present invention, the assembly including a torque rod with a torque rod retainer at one end and a pivot shaft at the other end.

FIG. 7 shows, from a first perspective, an inboard hinge construction between an inboard U-shaped channel and an inboard floor bracket.

FIG. 8 shows, from a second perspective, the inboard hinge construction between a first U-shaped channel supporting a split seat back and a first floor bracket on which the split seat back pivots.

FIG. 9 shows the outboard side construction between a second U-shaped channel supporting a split seat back and a second floor bracket on which the split seat back pivots.

### DETAILED DESCRIPTION OF THE INVENTION

The assist system 10 of the present invention provides an assist when opening a vehicle split seat back from an upright position and a lift assist when returning the seat back to the upright position from a horizontal, load floor position. The assist system allows the seat to pop off a latch when released and to fold down to the load floor position. It also provides a lift assist to the upright position. Some advantages of the assist system of the present invention are reducing assembly cost and complexity.

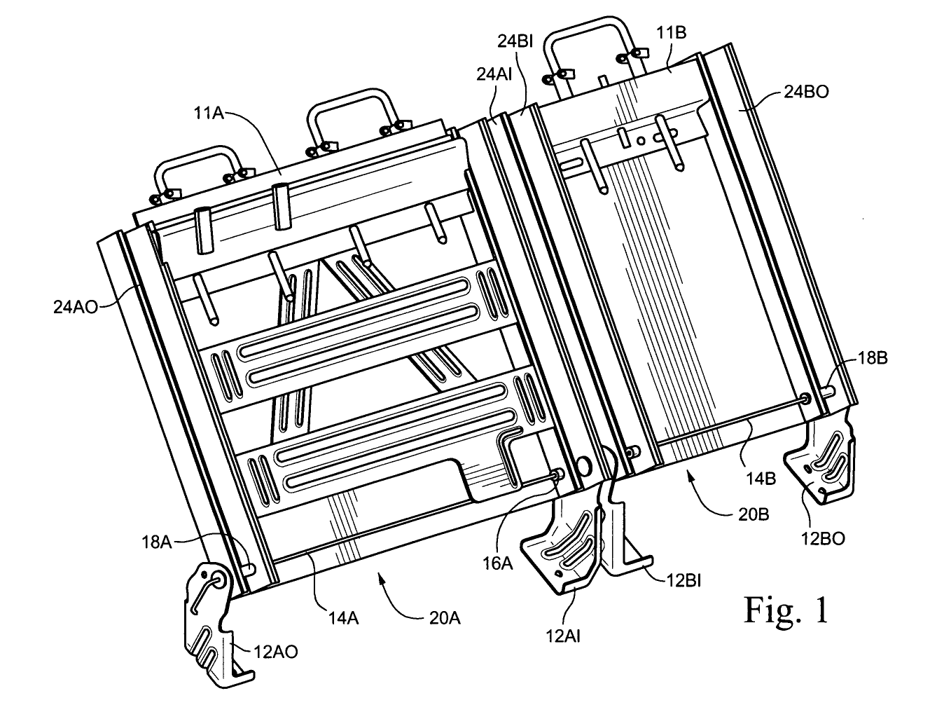

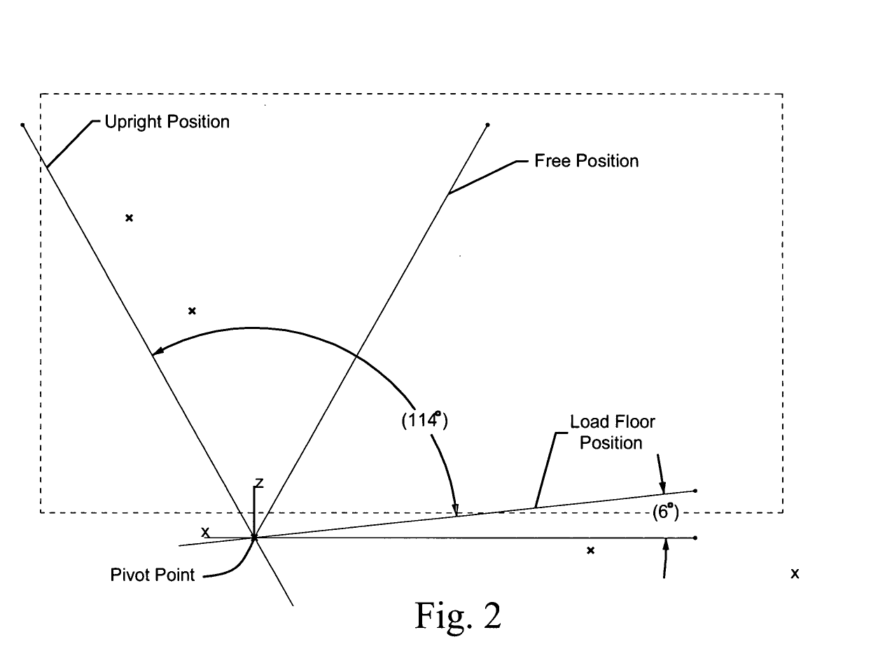

FIG. 1 shows 60-40 split seat backs 11A and 11B in an upright position with two torque rods 14A and 14B and four floor mounting brackets 12AO, 12AI, 12BI and 12BO on which the seat backs 11A and 11B pivot, respectively. FIG. 2 shows several seat back positions to which each of the 60-40 seat backs 11A and 11B can be pivoted. As shown in FIG. 2, there are three seat back positions, i.e., an upright position, a free position and a load floor position.

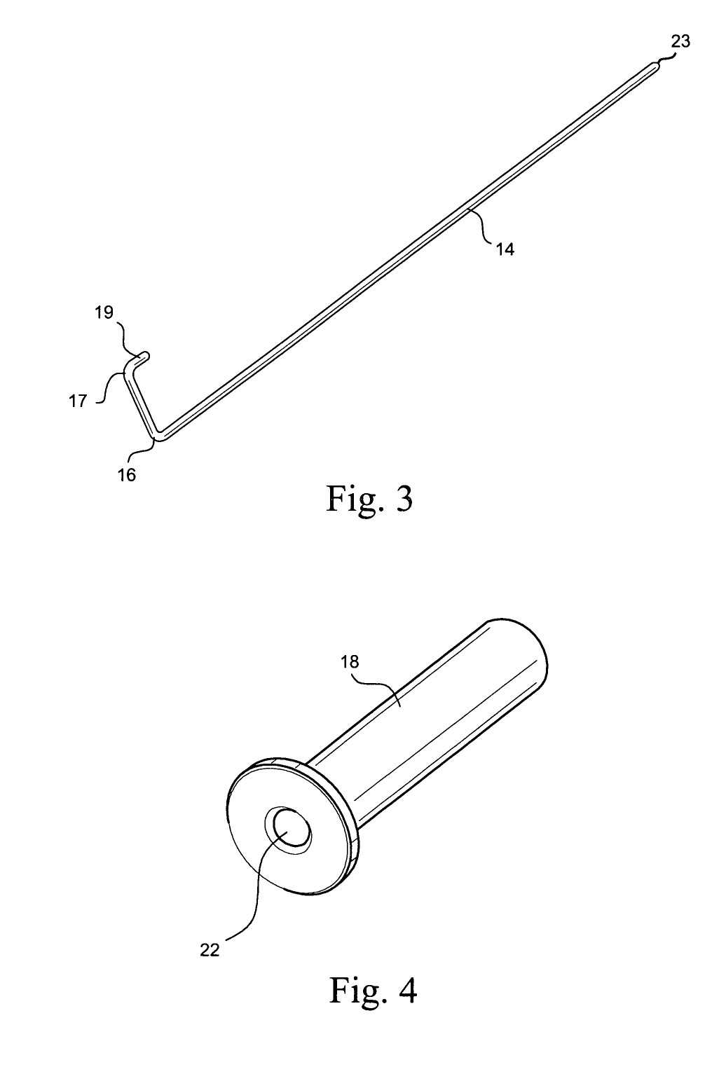

FIG. 3 shows one embodiment of a torque rod 14 with two bends 15 and 17 by which an end leg 19 of torque rod 14 is anchored to an outboard floor bracket 12. It should be noted that other shapes or configurations can be used for torque rod 14.

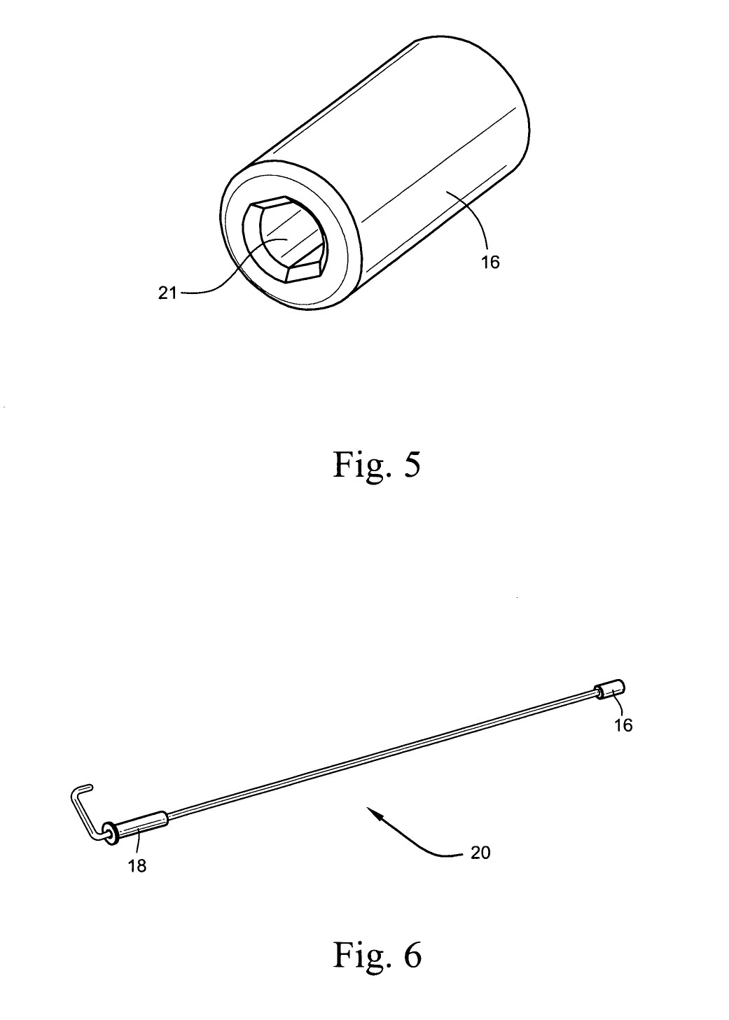

FIG. 4 shows one embodiment of a pivot shaft 18 with a clearance hole 22 in its center for torque rod 14 to pass through it. FIG. 5 shows one embodiment of a torque rod retainer 16A having a bore 21 with an inner profile complementing an outer profile of the torque rod 14, but it should also be noted that other profiles could be used. In such an instance, it may be desirable to use a device, such as a set screw in a threaded hole to hold the torque rod 14 within bore 21. A completed torque rod assembly 20 is shown in FIG. 6. The assembly 20 includes the torque rod 14, retainer 16 and pivot shaft 18.

The process for assembling the torque rod assembly is as follows. Preferably, torque rod 14 is formed with two bends 15 and 17. It should be noted, however, that other arrangements, including other numbers of bends, could be used to maintain pivot shaft 18 on torque rod 14 when pivot shaft 18 is slid onto torque rod 14. For this purpose, shaft 18 has a clearance hole 22 in its center for the toque rod 14 to pass through, as noted above. The torque rod retainer 16 is then press fit onto the other end 23 of the torque rod 14. The two bends 15 and 17 of the torque rod 14 anchor the torque rod 14 in the pivot shaft 18 and allow torque rod 14 to be attached to an outboard floor bracket 12AO or 12BO.

Four rails 24AO, 24AI, 24BI and 24BO, shown in FIG. 1 as preferably U-shaped channels, interface with two separate torque rod assist assemblies 20A and 20B, respectively. Each of the completed torque rod assemblies 20A and 20B is then assembled to the split seat backs 11A and 11B. Each of the outboard floor brackets 12AO and 12BO support a pivot shaft 18A and 18B, respectively, in which a torque rod 14A or 14B rotates.

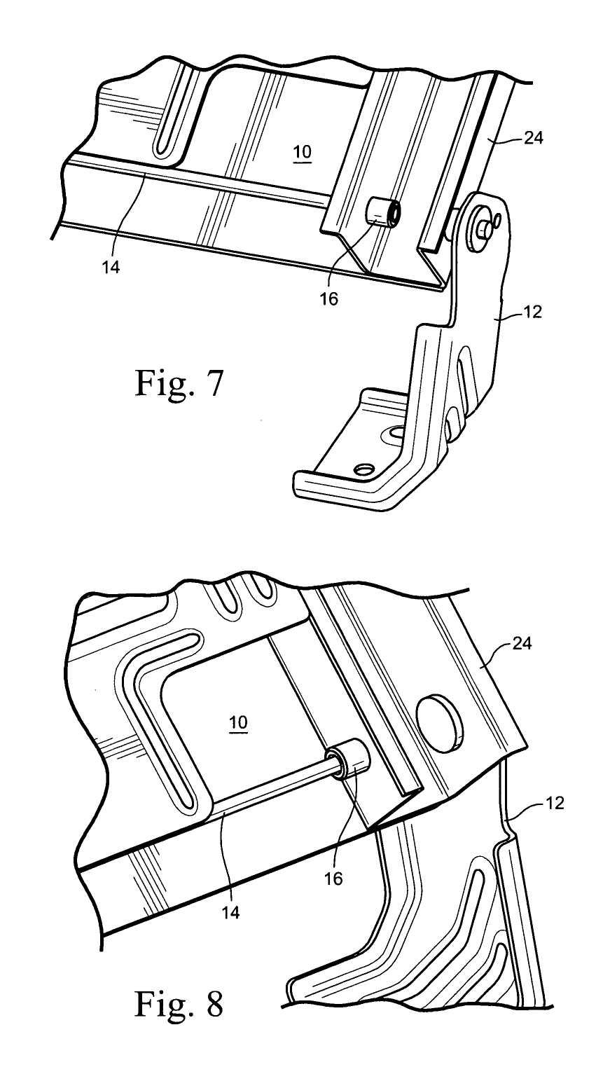

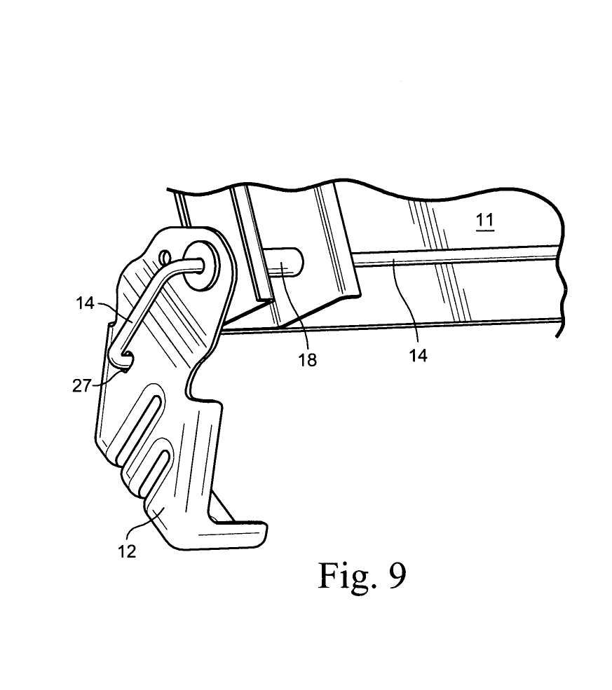

FIG. 7 shows the hinge construction between an inboard U-shaped channel 24 and a corresponding inboard floor bracket 12 from a first perspective. FIG. 8 shows the hinge construction between the inboard the U-shaped channel 24 and the corresponding inboard floor brackets 12 from a second perspective. FIG. 9 shows the construction between the outboard U-shaped channels 24 and the corresponding outboard floor bracket 12.

Referring, by way of example, to FIGS. 8 and 9, the torque rod assembly 20 is inserted through an opening, such as a hole, in the corresponding outboard floor bracket 12 and passes through another opening in the outer U-shaped channel 24. The torque rod assembly 20 then extends across the back of a corresponding seat back 11 to the inboard side, where the torque rod retainer 16 passes through a third opening in the inner U-shaped channel 24, resulting in the pivot shaft 18 being aligned through the outboard floor bracket 12 and through the outboard U-shaped channel 24. A leg 19 at the end of torque rod 14 is aligned and goes through a hole 27 in the outboard floor bracket 12. With the floor brackets restrained on the mounting surfaces, the seat back 11 is rotated to the free position angle (seat back at approximately 45 degrees). The pivot shaft 18 and the torque rod retainer 16 are welded to their respective U-shaped channels 24. The free position angle is where the torque rod 14 has no wind up.

Each seat side, i.e., the 60 side and the 40 side, work independently of each other. The 60-40 seat systems fold forward to provide a larger storage space in a vehicle's trunk. When the latch from the vehicle trunk compartment is released, the assist system of the present invention allows a seat back 11 to swing forward to the down position because of the energy stored in the twisted torque rod 14 from moving it from a free position to an upright position.

The same thing happens when the seat back 11 is in a down position. The assist system of the present invention gives lift assist to get the seat back 11 to the upright position, again because of the energy stored in the twisted torque rod 14 from moving it from the free position to the load position. Once the seat back 11 rotates past the free position, there is some resistance to get it to the upright stowed position, but this is acceptable.

Some of the advantages that can result from the use of the present invention include that the assist system can be easily manufactured, thereby reducing cost. The system also integrates easily to existing seat systems, again reducing cost. In addition, the cycle life of the assist system is greatly improved. This system can also be easily modified to change the performance of the up/down assist. The seat back free position angle of the torque rod 14 can be changed without modifying the torque rod diameter.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A seat back assist system for providing an assist when opening a vehicle seat back from an upright position and a lift assist when returning the seat back to the upright position from a load floor position, the system comprising:
first and second floor mounting brackets on which the seat back pivots,
first and second channels attached to first and second sides of the seat back and positioned adjacent to the first and second floor brackets, respectively,
a torque rod extending through a first opening in the first floor bracket and a second opening in the first channel and across the seat back and through a third opening in the second floor bracket,
a first end of the torque rod adjacent to the first opening in the first floor bracket including at least one bend for attaching the first end of the torque rod to the first floor bracket,
a torque rod retainer press fit onto a second end of the torque rod extending through the third opening in the second floor bracket, the torque rod retainer being attached to the second channel,
whereby the torque rod is spring-loaded due to twisting when the seat back is moved from a free position angle where the torque rod has no wind up, to either the upright position or to the horizontal, load floor position.

2. The seat back assist system of claim 1, further comprising a pivot shaft with a hole in its center for the torque rod to pass through, the pivot shaft being attached to the first channel so as to be rotated about the torque rod when the seat back is moved from a first position to a second position.

3. The seat back assist system of claim 1, wherein the first end of the torque rod includes at least two bends for attaching the torque rod to the first floor bracket.

4. The seat back assist system of claim 3, wherein the at least two bends in the first end of the torque rod cause the first end of the torque rod to be substantially u-shaped so that the torque rod is attached to the first floor bracket through an opening in the first floor bracket.

5. The seat back assist system of claim 1, wherein the torque rod serves as at least part of a pivot axis for the seat back.

6. The seat back assist system of claim 1, wherein the torque rod serves as a pivot axis for the first channel attached to the seat back.

7. The seat back assist system of claim 1, wherein the torque rod retainer is press fit onto the second end of the torque rod and welded to the second channel.

8. The seat back assist system of claim 2, wherein the pivot shaft is welded to the first channel.

9. The seat back assist system of claim 1, wherein the free position of the seat back is an angle of approximately 45 degrees.

10. The seat back assist system of claim 1, wherein the torque rod retainer has a bore within which the second end of the torque rod is inserted, the bore having an inner profile complementary to an outer profile of the torque rod.

11. The seat back assist system of claim 1, wherein the torque rod retainer has a bore within which the second end of the torque rod is inserted, the bore having an inner profile different from an outer profile of the torque rod and a set screw for holding the torque rod within the bore.

12. The seat back assist system of claim 1, wherein the first and second channels attached to first and second sides of the seat back are u-shaped.

13. An assist system for a split vehicle seat back comprising first and second seat backs, the system providing an assist when the first and/or second seat back(s) is/are opened from an upright position and a lift assist when the first and/or second seat back(s) is/are returned to the upright position from a load floor position, the system comprising:
first inboard and outboard floor mounting brackets on which the first seat back pivots,
second inboard and outboard floor mounting brackets on which the second seat back pivots,
first inboard and outboard channels attached to first inboard and outboard sides, respectively, of the first seat back and positioned adjacent to the first inboard and outboard floor brackets, respectively,
second inboard and outboard channels attached to second inboard and outboard sides, respectively, of the second seat back and positioned adjacent to the second inboard and outboard floor brackets, respectively,
a first torque rod extending through a first opening in the first outboard floor bracket and a second opening in the first outboard channel and across the first seat back and through a third opening in the first inboard floor bracket,
an outboard end of the first torque rod adjacent to the first opening in the first outboard floor bracket including at least one bend for attaching the outboard end of the first torque rod to the first outboard floor bracket,
a first torque rod retainer press fit onto an inboard end of the first torque rod extending through the third opening in the first inboard floor bracket, the first torque rod retainer being attached to the first inboard channel,
a second torque rod extending through a first opening in the second outboard floor bracket and a second opening in the second outboard channel and across the second seat back and through a third opening in the second inboard floor bracket,
an outboard end of the second torque rod adjacent to the first opening in the second outboard floor bracket including at least one bend for attaching the outboard end of the second torque rod to the second outboard floor bracket,
a second torque rod retainer press fit onto an inboard end of the second torque rod extending through the third opening in the second inboard floor bracket, the second torque rod retainer being attached to the second inboard channel,
whereby the first and second torque rods are spring-loaded due to twisting when the first and second seat back, respectively, are moved from a free position angle where the first and second torque rods have no wind up, to either upright position or to a horizontal, load floor position.

14. The seat back assist system of claim 13, further comprising first and second pivot shafts, each of the first and second pivot shafts having a hole in its center for the first and second torque rods, respectively, to pass through, the first pivot shaft being attached to the first outboard channel so as to be rotated about the first torque rod when the first seat back is moved between positions, the second pivot shaft being attached to the second outboard channel so as to be rotated about the second torque rod when the second seat back is moved between positions.

15. The seat back assist system of claim 13, wherein each of the outboard ends of the first and second torque rods includes at least two bends for attaching the first and second torque rods to the first and second outboard floor brackets, respectively.

16. The seat back assist system of claim 15, wherein the at least two bends in the outboard ends of the first and second torque rods cause each of the outboards end of the first and second torque rods to be substantially u-shaped so that the first and second torque rods are attached to the first and second outboard floor brackets through holes in the first and second outboard floor brackets, respectively.

17. The seat back assist system of claim 13, wherein the first and second torque rods serve as pivot axes for the first and second outboard channels attached to the first and second seat backs.

18. The seat back assist system of claim 13, wherein the first and second torque rod retainers are press fit onto the inboard ends of the first and second torque rods, respectively, and welded to the first and second inboard channels.

19. The seat back assist system of claim 14, wherein the first and second pivot shafts are welded to the first and second outboard channels.

20. The seat back assist system of claim 13, wherein each of the first and second torque rod retainers has a bore within which the inboard end of the first and second torques rod is inserted, respectively, each of the bores having an inner profile complementing an outer profile of the first and second torque rods, respectively.
